(19) United States
(12) Patent Application Publication
(10) Pub. No.: US 2016/0265588 A1
(43) Pub. Date: Sep. 15, 2016

(54) EXTERNALLY PRESSURIZED POROUS MEDIA GAS BEARING FOR USE IN VALVES AND PREVENTING FUGITIVE EMISSIONS OF THE SAME

(71) Applicant: NEW WAY MACHINE COMPONENTS, INC., Aston, PA (US)

(72) Inventors: Andrew DEVITT, Media, PA (US); Richard POLLICK, West Chester, PA (US)

(73) Assignee: NEW WAY MACHINE COMPONENTS, INC., Aston, PA (US)

(21) Appl. No.: 15/069,679

(22) Filed: Mar. 14, 2016

Related U.S. Application Data
(60) Provisional application No. 62/132,719, filed on Mar. 13, 2015.

(51) Int. Cl. F16C 32/06; F16C 33/72; F16J 15/40; F16K 31/08; F16K 5/08

(52) U.S. Cl. CPC F16C 32/0618; F16K 31/088; F16K 5/08; F16J 15/40; F16C 33/72

(57) ABSTRACT

In order to drastically improve the functionality of flow control, externally-pressurized porous media gas bearings is introduced into valves. The porous media gas bearings mitigate two of the biggest issues with the current technology, which are: (1) leakage of fugitive emissions, and (2) high breakaway torque values for actuating valves. By employing externally-pressurized porous media bearings, fugitive emissions are completely eliminated, and valves can be rotated effortlessly due to the non-contact nature of porous media gas bearings.

### REFERENCE TO RELATED APPLICATIONS

This application claims the benefit of U.S. Provisional Application No. 62/132,719, filed Mar. 13, 2015, whose disclosure is hereby incorporated by reference in its entirety into the present disclosure.

### FIELD OF INVENTION

This application is generally related to the actuation of a variety of valve types and sealing the same from escaping fugitive emissions. The valves most benefitting from the subject invention include, but are not limited to, plug valves, butterfly valves, gate valves, valves used in the oil and gas industry, in refineries, in power plants, in chemical plants, in waste process plants, in applications where sealing of gases is critical, and in applications which currently require significant torque for opening and closing valves.

### BACKGROUND

Valves are used to prevent, permit, or regulate the flow of gases, liquids, powders, or slurries. Two key issues with state-of-the-art valves include: (1) the release of fugitive emissions (as in the case of valves that are intended to regulate gases, and (2) the fact that certain valves, especially large valves, oftentimes require a high amount of torque during opening, adjusting or closing of the valve.

The Environmental Protection Agency has made continued efforts to reduce and regulate the release of fugitive emissions. However, this still involves the fact that almost all valve stems are sealed using “packing” material. Over time, the packing needs to be replaced to maintain EPA compliance, and valve leakage must be monitored as part of the EPA's Leak Detection and Repair (LDAR). Regardless of how good the packing is, no technology is considered leak-free with zero emissions.

With regard to operating valves, especially via handwheels, the breakaway torque values required are often quite high, and require special tools or equipment for actuating the valves. Without special tools or equipment, manual operation of a handwheel can require more than one person in order to actuate certain valves, due to the high breakaway torques. There have been studies performed indicating that human factors, such as musculoskeletal problems, can occur due to physical exertion associated with manually operating valves with high breakaway torque values. Current solutions used to avert such human factors include equipment such as cable drive systems to actuate valves, portable valve actuators, and a plethora of actuation equipment powered by pneumatic, hydraulic, or electric power.

In brief, valve assemblies have not changed much in the last 100 years. And, inherent in these old, basic designs are some of today's biggest problems: fugitive emissions and hard-to-actuate valves. The current art has not had a good redesign which will get to the root of these two issues.

### SUMMARY

Briefly stated, the invention utilizes porous materials as a restrictive element to a pressurized fluid or gas to the bearing/sealing lands in a valve. This pressure reduces or eliminates friction between the stationary and moving surfaces.

The subject invention alternatively uses gas-pressurized porous media bearing gaps to prevent the escapement of fugitive emissions, by virtue of the fact that the supplied aerostatic gas pressure will present a barrier at the face of the porous media, opposing any fugitive emissions.

In the case of valve actuation, the use of externally, aerostatic-gas-pressurized porous media, acting as an air bearing, essentially will create a non-friction surface, which will allow valves to be actuated by hand, with virtually no breakaway torque.

The subject invention solves several key issues contained in the current art: (1) it eliminates fugitive emissions completely by invoking the use of externally-pressurized porous media as a bearing and seal, and (2) the use of externally-pressurized porous media allows for effortless, manual operation of valves, without the need for special equipment or tooling for overcoming high breakaway torque values.

### BRIEF DESCRIPTION OF THE DRAWINGS

The foregoing summary, as well as the following detailed description of the preferred embodiments, will be better understood when read in conjunction with the appended drawings. For the purpose of illustrating the invention, there are particular embodiments and configurations shown in the drawings. It should be understood, however, that the scope of invention is not limited to the precise arrangement shown.

FIG. 1 shows an example of a prior art valve stem with the sealing feature being packing material.

FIG. 2. shows an example of a prior art plug (or similar) valve.

FIG. 3 shows an example of a valve stem with the sealing feature being externally-pressurized porous media, also allowing ease-of-rotation

FIG. 4A shows an example of a plug valve using externally-pressurized porous media as a sealing and bearing feature

FIG. 4B shows porous media for a face seal.

FIG. 4C shows porous media for an angled seal/seat.

FIG. 4D shows porous media for a spherical seal/seat.

FIG. 5 shows an example of a valve which uses externally-pressurized porous media as a bearing feature, and having a containment with a magnetic-drive feature to prevent emissions.

FIG. 6 shows an example of an externally-pressurized porous media face seal to prevent emissions.

### DETAILED DESCRIPTION OF THE PREFERRED EMBODIMENTS

Certain terminology is used in the following description for convenience only and is not limiting. The words “front,” “back,” “left,” “right,” “inner,” “outer,” ^{“}upper,” “lower,” “top,” and “bottom” designate directions in the drawings to which reference is made. Additionally, the terms “a” and “one” are defined as including one or more of the referenced item unless specifically noted otherwise. A reference to a list of items that are cited as “at least one of a, b, or c” (where a, b, and c represent the items being listed) means any single one of the items a, b, or c, or combinations thereof. The terminology includes the words specifically noted above, derivatives thereof, and words of similar import.

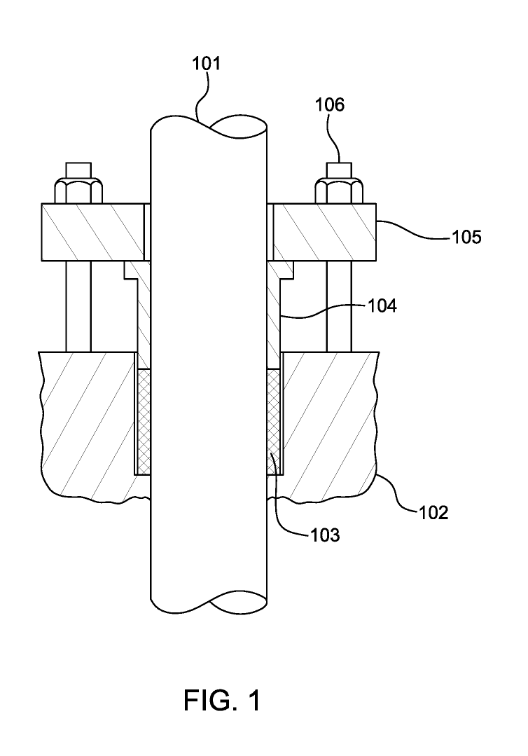

As illustrated in FIG. 1, prior art valve stems are comprised of a stem 101, a valve body 102, a yoke 105, a gland follower 104, a gland stud 106, and packing 103. In order to seal the valve stem 101 from allowing emissions to the atmosphere from the valve, the gland stud 106 is tightened, which, in turn, creates a downward force on the yoke 105 and gland follower 104, and eventually compresses the packing 103 so that it forms a seal around the stem 101. In time, the packing 103 will begin to relax, and will leak, at which point the gland stud 106 will need re-tightened. Eventually, the packing 103 will leak to the point that the packing will need to be replaced.

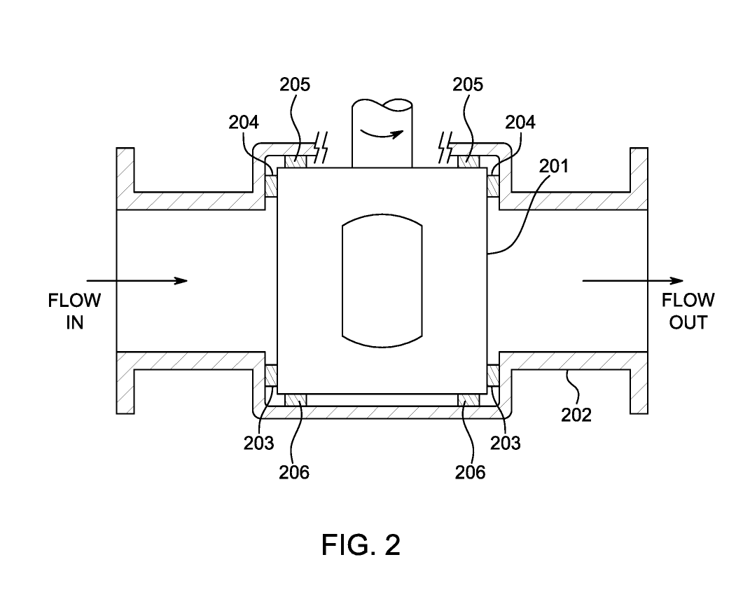

Another example of prior art is illustrated in FIG. 2, which illustrates a typical plug valve, which allows or prevents flow when the valve is rotated. The FIG. 2 plug valve is comprised of a valve body 202, a plug 201, sleeves 203 and 204 which act as a sealing mechanism, a collar 205 which also acts as a sealing mechanism, and a possible seal/seat 206. Other types of valves, such as gate valves, ball valves, and others all have sealing surfaces or valve seats which have a similar function as the sleeves 203 and 204, the collar 205, and the seal/seat 206 as shown in FIG. 2. There are two issues with the current technology. First, the sealing is not leak-proof, and thus fugitive emissions result. Furthermore, the seals or valve seats wear and require replacement in time. Additionally, the materials used for current art seals and valve seats are not conducive to higher temperatures. Regarding the second main issue, the current art sleeves, seals, or seats may cause the valves to have high breakaway torques which become problematic for operators, as described earlier.

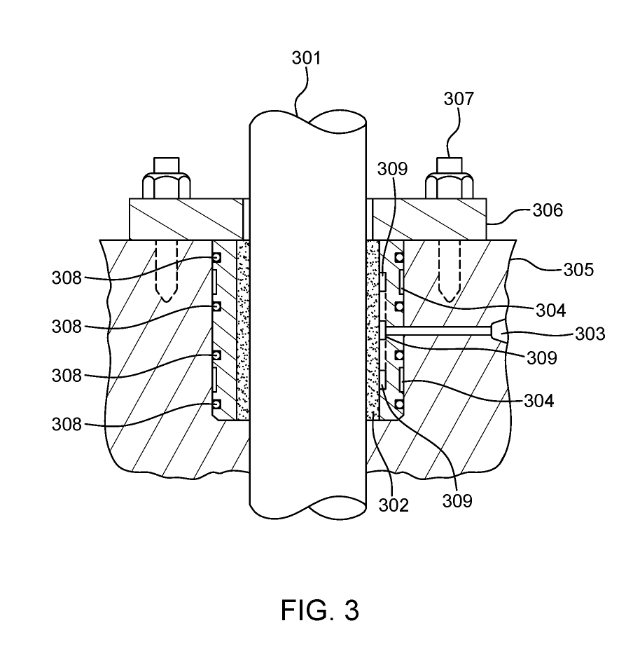

FIG. 3 illustrates how an externally-pressurized porous media cylindrical member can be used to provide valve stem sealing which prevents fugitive emissions. This illustration is comprised of valve stem 301, valve body 305, a porous media seal 302, a port 303 for externally-pressurized incoming gas, a plurality of plenums 309 that distribute the pressurized gas to the porous media, a yoke 306, studs 307, and a cylindrical gap 304 between a cylindrical member and valve body 305. For this arrangement, the porous media seal 302, which is substantially in the form of a cylinder, is installed in the valve body 305. The yoke 306 functions to hold the porous media seal 302 in place to prevent axial movement under pressurization. The studs 307 hold the yoke in place. Optionally, the cylindrical gap may be filled with epoxy to rigidly hold the cylindrical member to within the valve body.

Externally-pressurized gas is introduced via port 303, and is directed through the plurality of plenums 309, and into the porous media seal 302. The pressurized gas flows through the porous media seal 302 and creates a very thin gap of pressurized gas between the outside diameter of the valve stem 301 and the inside diameter of the porous media seal 302. As long as the pressure in this gap exceeds any opposing pressure coming from the valve, leakage will be prevented from coming out of the valve stem 301, and therefore fugitive emissions will be prevented.

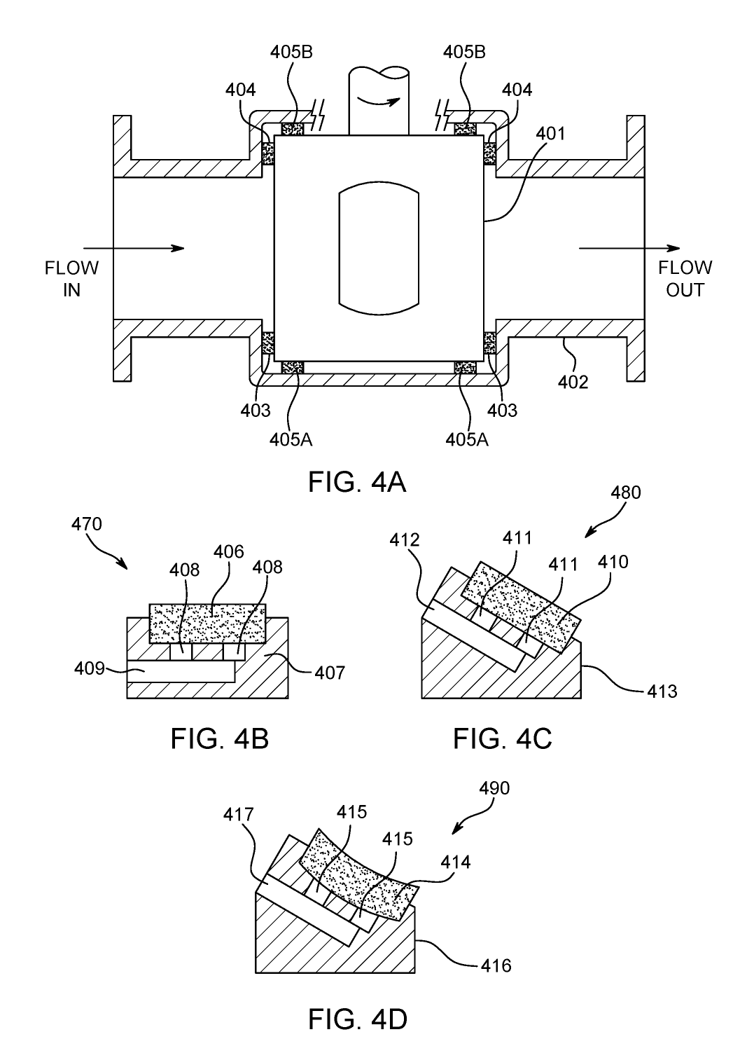

FIG. 4 illustrates how porous media technology can be used in a plug valve for the purpose of providing sealing, as well as having frictionless turning capability. Porous media cylindrical seals 403 and 404 or face seals 405A and 405B are inserted in valve body 402. Several possibilities exist during operation. Externally-pressurized gas is injected into the porous media seals 403 and 404 or 405A and 405B in the same manner as described in FIG. 3. The pressure in the air gap between the seals 403, 404 or 405A and 405B and the seal body 402 is maintained at a pressure which is higher than the pressure flowing through the valve. Hence, when the plug 401 is shut, the gap pressure is higher than the pressure of the fluid flowing into the valve, and the fluid is not able to penetrate the higher pressure in the air gap. When the plug 401 is in the open position, the air gap pressure is still higher than the flowing fluid pressure, and the flowing fluid is unable to leak past the seals 403 and 404 or 405A and 405B. Furthermore, the air gap produced by the introduction of externally-supplied gas pressure into the seals 403 and 404 or 405A and 405B creates a non-friction condition at the plug interface which allows the plug 401 to be effortlessly turned to the open or closed positions. This is hereby contrasted with the current art's high breakaway torques that often exist when trying to turn such valves. The teaching shown for FIG. 4 has far reaching applications to other types of valves, such as gate, ball, and other types of valves wherein the porous media seals can replace valve seats, thus enabling both sealing and ease of rotation.

FIGS. 4B, 4C and 4D show porous media arrangements for a face seal 470, an angled seal/seat 480 or a spherical seal/seat 490, respectively. In FIG. 4B, housing 407 comprises a channel 409 that directs injected gas into plenums 408 and into porous media 406. In FIG. 4C, housing 413 comprises a channel 412 that directs injected gas into plenums 411 and into porous media 410. In FIG. 4D, housing 416 comprises a channel 417 that directs injected gas into plenums 415 and into porous media 414.

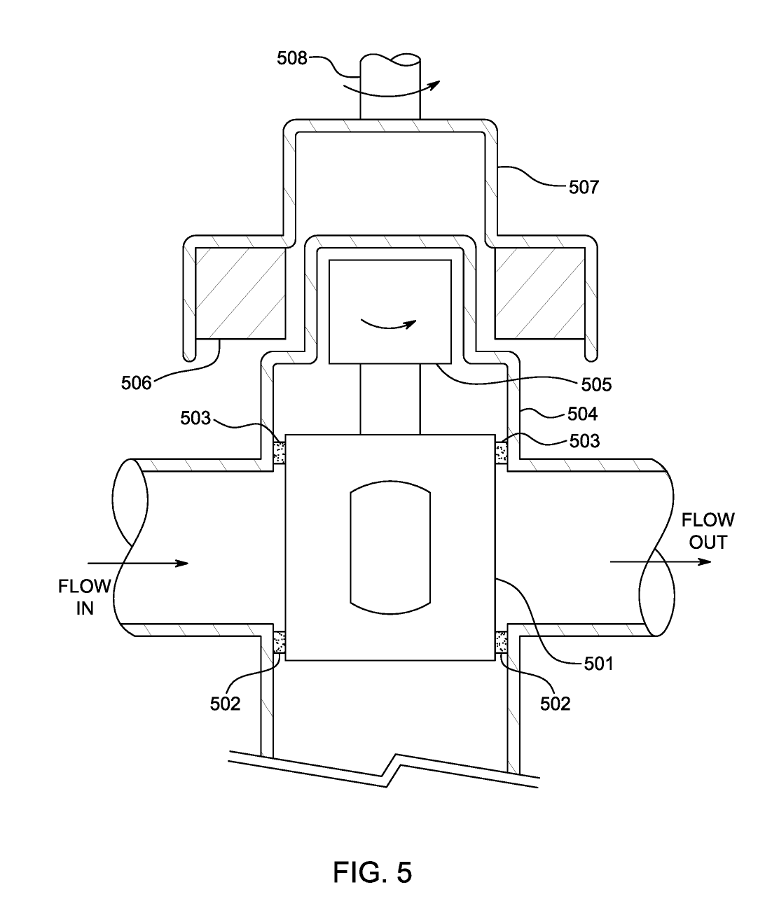

FIG. 5 is an illustration which builds upon the teaching of FIG. 4, but also introduces a further novelty pertaining to sealing functionality. Gas bearing sleeves 502 and 503 are installed into valve body/containment 504, and these seals function on the basis of externally-pressurized gas in the same ways as presented in FIGS. 3 and 4. Plug 501 is connected to a driven magnet 505, which is acted upon by magnetic force via a driving magnet 506 through the valve body/containment 504. The driving magnet is installed in a casing 507 which is attached to a shaft 508.

During operation, the casing 507 and driving magnet 506 are rotated, causing a magnetic field to act upon the driven magnet 505, thus causing the valve plug 501 to rotate to the open or closed position. The externally-pressurized gas bearing sleeves 502 and 503 allow the valve to open or close effortlessly due to the air gap created by pressure in the air gap which is higher than the pressure of the fluid in the valve. When the valve reaches its intended open or closed position, gas pressure supplied to the gas bearing sleeves 502 can be shut off. The valve will continue to perform its function in the open or closed position. When it is desired to actuate the valve from the opened-to-closed, or closed-to-opened position, the externally-supplied pressure to the gas bearing sleeves 502 and 503 is turned on, and the valve plug 501 instantly pops free by virtue of the air film created at the bearing-to-plug interface, thus allowing the valve to be operated in a frictionless manner. Furthermore, the valve body/containment prevents any leakage out of the valve at all times. The teaching shown for FIG. 5 has far reaching applications to other types of valves, such as gate, ball, and other types of valves wherein the porous media bearings can replace valve seats, thus enabling ease of rotation, as well as the fact that the magnet-containment methodology can provide sealing at all times.

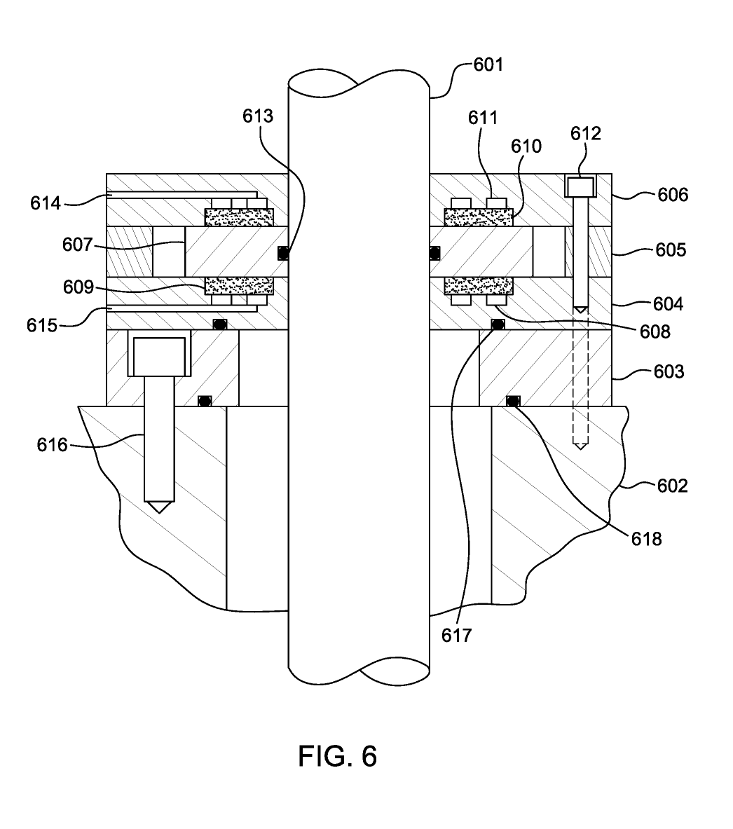

An alternative face type seal is presented in FIG. 6. In this arrangement, a runner 607 is coupled to a rotating shaft 601 (which could be a valve stem) by an O-ring 613. On opposing sides of the runner 607 are two porous media seal faces 609 and 610. These face seals are installed into housings 604 and 606, and are supplied with externally-pressurized gas via ports 614 and 615. The externally-pressurized gas flows into plenums 608 and 611, and then flows through the porous media seal faces 609 and 610. The pressure introduced into the seal faces creates an air gap between the seal faces and the runner, which maintains a pressure which is higher than the opposing pressure which leaks up to this point from the valve. The gap pressure causes the fluid or gas in the valve to not be able to penetrate, and hence the valve stem is completely sealed. Adjacent to the runner 607 is spacer 605, which separates the two housings 604 and 606, and these components are all held together by bolts 612 (it should be noted that while only one bolt is shown, the assembly may use 4 or more such bolts). The seal assembly is attached to the valve body 602 via certain number of the 612 bolts which penetrate through the entire seal assembly and into the valve body 602. In certain cases optional adaptive mounting member 603 and bolts 616 may be required.

In addition to the sealing functionality taught above, the FIG. 6 arrangement is also able to be used as a non-contact thrust bearing for rotating equipment. That is, by attaching the runner 607 to a rotating shaft 601, the faces 609 and 610 act as non-contact axial bearing faces. The externally-pressurized gas to the faces 609 and 610 create an air gap between the runner 607 and seal faces, and is capable of bearing axial loads imparted on the rotating shaft. It is noted that the attachment of the runner 607 to the shaft 601 can be accomplished with hard-mounting in lieu of O-ring 613. In such case, a set screw or thrust collar, as is typically known in the art, can be used.

While preferred embodiments have been set forth in detail with reference to the drawings, those skilled in the art who have reviewed the present disclosure will readily appreciate that other embodiments can be realized within the scope of the invention, which should therefore be construed as limited only by the appended claims.

What is claimed is:

1. An aerostatic bearing-seal for valves, comprising:
one or more circumferential porous media sleeves, each circumferential porous media sleeve surrounding an associated valve stem; and
conductive passages for communicating externally pressurized gas into at least one plenum and into the porous media.

2. The aerostatic bearing-seal of claim 1 wherein the valve is sealed and prevents fugitive emissions due to the externally pressurized gas in a gap between the porous media sleeve and the valve stem.

3. The aerostatic bearing-seal of claim 1 wherein the valve stem rotates without friction when external gas pressure is supplied to the porous media.

4. The aerostatic bearing-seal of claim 1 further comprising a containment that completely surrounds the valve stem.

5. The aerostatic bearing-seal of claim 4 wherein the valve stem includes a first driven magnet, which is driven by a second driving magnet which is exterior to the first driven magnet.

6. The aerostatic bearing-seal of claim 1 in which the porous media sleeve may be comprised of a material selected from the group consisting of graphite, carbon, silicon carbide. Tungsten carbide, porous diamond, diamond-like coated, alumina, and carbon-carbon.

7. The aerostatic bearing-seal of claim 1 wherein the porous media sleeve is manufactured using a process selected from the group consisting of:
ceramic casting and 3-D printing.

8. An aerostatic seal, comprising:
one or more housings with a porous media face;
an opposing runner attached to the rotating member;
conductive passages for communicating gas pressure into at least one plenum and into the porous media; and
an interface block for mounting to a main body.

9. The aerostatic seal of claim 8 wherein a valve is sealed and prevents fugitive emissions due to external gas pressure in the gap between the porous media faces and the opposing runner.

10. The aerostatic seal of claim 8 wherein the porous media faces act as a thrust bearing for axial loading acting upon the rotating member.

11. The aerostatic seal of claim 8 in which the porous media may be comprised of any porous or sintered material such as graphite, carbon, silicon carbide, Tungsten carbide, porous diamond, diamond-like coated, alumina, carbon-carbon, etc. The manufacture of porous media may employ ceramic casting techniques commonly known in the art, but may also employ other methods such as 3-D printing.

12. An aerostatic bearing-seal for valves, comprising:
a valve body;
a valve stem contained within the valve body; and
at least one porous media sleeve separating the valve body and the plug;
wherein externally pressurized gas is introduced to the gap between the porous media sleeve and the plug to act as a seal.

13. The aerostatic bearing-seal of claim 12 further comprising:
conductive passages for communicating the externally pressurized gas into at least one plenum that distributes the externally pressurized gas into the porous media.

14. The aerostatic bearing-seal of claim 12 wherein the seal may be a face seal, an angled seal to mate with an angled seat, or a spherical seal to mate with a spherical seat.

15. The aerostatic bearing-seal of claim 12 wherein the valve stem is a plug.
